(19) United States
(12) Patent Application Publication
(10) Pub. No.: US 2015/0229782 A1
(43) Pub. Date: Aug. 13, 2015

(54) NOTIFICATION VOLUME ADJUSTMENT BASED ON DISTANCE FROM PAIRED DEVICE

(71) Applicant: NXP B.V., Eindhoven (NL)

(72) Inventors: Edwin ZUIDEMA, Eindhoven (NL); Vlatko MILOSEVSKI, Eindhoven (NL)

(73) Assignee: NXP B.V., Eindhoven (NL)

(21) Appl. No.: 14/178,085

(22) Filed: Feb. 11, 2014

(51) Int. Cl. H04M 19/04; H04W 4/00

(52) U.S. Cl. CPC H04M 19/042; H04W 4/008; H04W 4/04

(57) ABSTRACT

System and method for adjusting a sound notification volume a mobile device are disclosed. Accordingly, the transmission signal strength is measured at the mobile device for a transmission link between the mobile device and a smart companion device that is paired with the mobile device. Subsequently, using a calibration data and the measured signal strength, a distance between the mobile device and the smart companion device is estimated. Then, using a configuration that is preset in the mobile device and the estimated distance, the sound notification volume of the mobile device is adjusted.

### BACKGROUND

With an unprecedented adoption of technologies by the masses, mobile phones and mobile devices have virtually become necessities of life. Recently, gadgets that compliment mobile devices have started to become popular as for example smart watches that connect to mobile devices. With the use of technologies such as Bluetooth, it has become possible to connect various types of external devices to mobile devices such as smart watches, wireless headphones, smart displays, etc. It is no longer necessary to keep a mobile device within the ringtone hearing range if the user of the mobile device is wearing, for example, a smart watch.

These smart companion devices remain in constant communication with the host mobile device. These communication links are typically used for exchanging data and notifications between one or more companion device and a mobile device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for adjusting a sound notification volume a mobile device are disclosed. Accordingly, the transmission signal strength is measured at the mobile device for a transmission link between the mobile device and a smart companion device that is paired with the mobile device. Subsequently, using a calibration data and the measured signal strength, a distance between the mobile device and the smart companion device is estimated. Then, using a configuration that is preset in the mobile device and the estimated distance, the sound notification volume of the mobile device is adjusted.

In another embodiment, a computer readable media for adjusting a sound notification volume a mobile device, embodied in the mobile phone is disclosed. The computer readable media includes programming instructions, which when executed by a processor of the mobile phone performs an operation. Accordingly, the transmission signal strength is measured at the mobile device for a transmission link between the mobile device and a smart companion device that is paired with the mobile device. Subsequently, using a calibration data and the measured signal strength, a distance between the mobile device and the smart companion device is estimated. Then, using a configuration that is preset in the mobile device and the estimated distance, the sound notification volume of the mobile device is adjusted.

In yet another embodiment, a mobile device is disclosed. The mobile device includes a transmission signal strength monitor, a data store for storing a calibration data for mapping different values of transmitted signal strength to a distance, a data store for storing a configuration for performing configured operations based on the distance, and a user interface to change the configuration.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. Advantages of the subject matter claimed will become apparent to those skilled in the art upon reading this description in conjunction with the accompanying drawings, in which like reference numerals have been used to designate like elements, and in which:

FIG. 1 is an exemplary schematic of a mobile device and a smart companion device in accordance with one or more embodiment;

FIG. 2A illustrates an exemplary method for adjusting sound notification volume of a mobile device based on distance sensing by the mobile device in accordance with one or more embodiments; and

FIG. 2B illustrates an exemplary method for adjusting sound notification volume of a mobile device based on distance sensing by the companion device in accordance with one or more embodiments.

### DETAILED DESCRIPTION

Since it is no longer necessary to keep a mobile device within a reasonable ringtone hearing zone while wearing a smart companion device, the issue arises when a communication is received at the mobile device and the mobile device being at some distance away from the user, the user is unable to hear the communication notification sound. The notification sound may be the ringtone when an audio/video call is received by the mobile device or email notification or text message notification or any other sound notification triggered by an application executing in the mobile device. Embodiments of the present invention addresses this issue by adjusting the sound volume of the mobile device based on the distance between the mobile device and the companion device.

Further, often times, a user put a mobile phone on mute, for example, during meetings and then forgets to un-mute the volume. The embodiments of the present invention provides automatic un-muting when the distance between the user (who is wearing a smart companion device) and the mobile device exceeds a preset threshold or the connection with the smart companion device is lost.

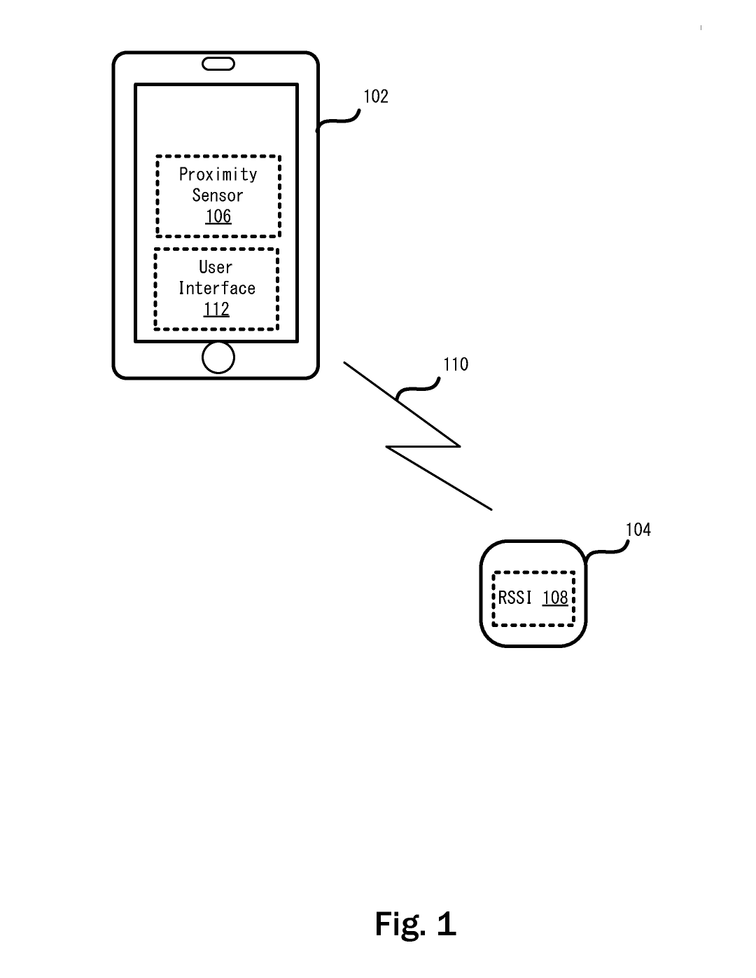

FIG. 1 an exemplary schematic of a mobile device 102 and a smart companion device 104. The smart device 104 is connected (typically called “paired”) to the mobile device 102 via a wireless communication link 110. The wireless communication link 110 may be a Bluetooth link or a Wi-Fi link. In another embodiment, the smart companion device 104 may not be connected directly to the mobile device 102. Instead, the smart companion device 104 and the mobile device 102 connect to a network device (not shown) and communicate with each other through the network device. In another embodiment, the mobile device 102 and the smart companion device 104 connects to each other directly as shown when there is no network device is available and switches to a communication mode via the network device when the network device becomes available. The example of a network device may be a Wi-Fi router or a mobile communication tower. Switching to or using the network device, when available, may provide battery saving because the mobile device 102 is likely to be connected to either a Wi-Fi router, when available or a mobile data network for communication with external devices such as other users' mobile devices or servers. In these cases, the direct communication link 110 may be shutdown to save battery life. However, in one embodiment, the direct communication link 110 is revived at preset intervals, for a short period of time, for the purpose of sensing the distance between the mobile device 102 and the smart companion device 104.

The mobile device 102, in one embodiment, includes a proximity sensor 106. The proximity sensor 106 may be a software that executes a method to sense the signal strength of the direct communication link 110. If the direct communication link 110 is not active, the proximity sensor 106 revives the direct communication link 110 for a period that is necessary to execute the method.

To save the battery power, the mobile device 102 is equipped with varying the transmit power based on the distance of a connected device, e.g., the smart companion device 104. The signal transmitters that are built into the mobile device 102 to facilitate Bluetooth or Wi-Fi communication vary signal distance based on various criterions including a rate of packet loss. The proximity sensor 106 may include a software module to store pre-calculated data to map a particular signal strength value to the distance to the connected device. Based on the derived distance from the signal strength and a user configuration, the mobile phone 102 is instructed to either increase or reduce sound notification volume or un-mute the volume.

The smart companion device 104 may also include a received signal strength indicator (RSSI) module 108 to measure the signal strength of the received signal via the direct communication link 110. In one embodiment, either the proximity sensor 106, if available, or the RSSI module 108, if available, may measure the distance. In another embodiment, if both the proximity sensor 106 and the RSSI module 108 are available, both of these module may measure the distance and subsequently the two measurements may be combined to have better accuracy of measurement. In one embodiment, the user of the mobile device 102 may configure the uses of the proximity sensor 106 and the RSSI module 108.

In one embodiment, when the distance to the smart companion device 104 is beyond a second threshold or when the smart companion device 104 is unreachable, the sound notification volume is set to the maximum value. Alternatively, depending upon a user configuration, the sound notification volume is muted when the distance is beyond the second threshold value or when the smart companion device 104 is unreachable. In yet another embodiment, this such conditions, the sound notification volume is set be changed manually by the user of the mobile device 102.

A user interface 112 is provided to enable the user of the mobile device 102 to configure various settings as described herein. For example, the user interface 112 may allow the user to set various threshold distances, turn on or off the method to automatically adjust the sound notification volume based on the distance from the smart companion device 104, set “out of range” behavior. In another embodiment, the granularity of the sound notification volume adjustment may also be configured via the user interface. For example, the user may configure ranges of distances in which the sound notification volume may not be automatically adjusted, as for example, keep the sound notification volume at a preset value between 2 feet to 4 feet. In one embodiment, for example in Android based mobile devices, the user interface may be provided in sound settings section of the mobile device 102. In one embodiment, the user interface is only available when at the smart companion device 104 is connected or paired with the mobile device 102. It should be noted that a person of ordinary skills in the art would appreciated that several other similar settings may be provided without deviating from embodiments described herein.

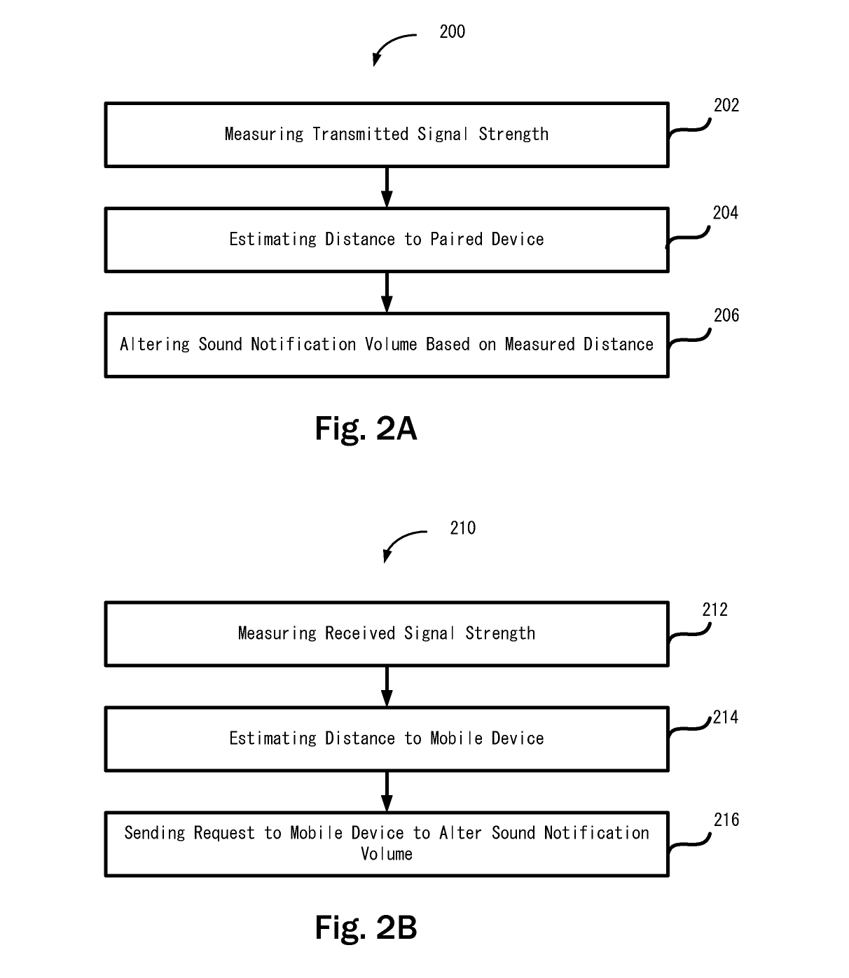

FIG. 2A illustrates an exemplary method 200 for adjusting sound notification volume of a mobile device 102 based on distance sensing by the mobile device 102. Accordingly, at step 202, the proximity sensor 106, with the help of the signal transmitter of the mobile device 102, measures the transmit signal strength. Subsequently, at step 204, the proximity sensor 106 (or a separate software module in another embodiment) calculates the distance between the mobile device 102 and the smart companion device 104 based on the transmit signal strength and the calibration data stored in the mobile phone 102. The calibration data maps the signal strength to the distance of the receiving device, e.g., the smart companion device 106. In one embodiment, the calibration data may be updated from a server (not shown) via the Internet. Alternatively, in some embodiment, the calibration data may be manually inputted. At step 206, the sound notification volume is adjusted or altered based on preset configuration and the measured distance. Other operations may also be performed based on user configuration as set by the mobile device manufacturer or the user of the mobile device 102. The examples of these other operations may be muting/unmuting the sound notifications or setting the granularity of sound notification adjustments, etc.

FIG. 2B, illustrates an exemplary method 210 for adjusting sound notification volume of a mobile device 102 based on distance sensing by the smart companion device 104. Accordingly, at step 212, the smart companion device 104 measures the received signal strength using the RSSI module 108. At step 214, the smart companion device 104 estimates the distance to the mobile device 102 based on the measured received signal strength. Alternatively, the smart companion device 104 may send the measured received signal strength to the mobile device 102 for further calculations according to the method 200 using a calibration data for the received signal strength.

When the distance calculations are performed at the smart companion device 104, at step 216, the smart companion device 104 sends a request to the mobile device 102 to adjust the sound notification volume according to the measured distance.

It should be noted that even though the disclosure uses a mobile phone and smart companion device to explain various embodiments, a person of ordinary skills will realize that the embodiments described herein may also be used in other applications that require a distance based altering of properties of a mobile device.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for adjusting a sound notification volume a mobile device, comprising:
measuring transmission signal strength at the mobile device for a transmission link between the mobile device and a smart companion device that is paired with the mobile device;
using a calibration data and the measured signal strength, estimating a distance between the mobile device and the smart companion device; and
using a configuration that is preset in the mobile device and the estimated distance, adjusting the sound notification volume of the mobile device.

2. The method of claim 1, wherein the measuring of the transmission signal strength is performed using the signal transmitter module of the mobile device.

3. The method of claim 1, wherein the calibration data provides a mapping between different values of the measured transmission signal strength and distances of the mobile device to the smart companion device.

4. The method of claim 3, wherein the calibration data is prepared for the mobile device by a user of the mobile device.

5. The method of claim 3, wherein the calibration data is prepared for the mobile device by a manufacturer of the mobile device.

6. The method of claim 1, wherein the configuration includes a distance threshold, the distance threshold defines a user selected operation that is performed when the distance between the mobile device and the smart companion device exceeds the distance threshold.

7. The method of claim 6, wherein the distance threshold is configurable by a user of the mobile device through settings of the mobile device.

8. The method of claim 1, wherein the configuration includes an operation that is performed when the smart companion device is unreachable or turned off.

9. A non-transitory computer readable media for adjusting a sound notification volume a mobile device, embodied in the mobile phone, the computer readable media including programming instructions, which when executed by a processor of the mobile phone performs an operation, the operation comprising: comprising:
measuring transmission signal strength at the mobile device for a transmission link between the mobile device and a smart companion device that is paired with the mobile device;
using a calibration data and the measured signal strength, estimating a distance between the mobile device and the smart companion device; and
using a configuration that is preset in the mobile device and the estimated distance, adjusting the sound notification volume of the mobile device.

10. The non-transitory computer readable media of claim 9, wherein the measuring of the transmission signal strength is performed using the signal transmitter module of the mobile device.

11. The non-transitory computer readable media of claim 9, wherein the calibration data provides a mapping between different values of the measured transmission signal strength and distances of the mobile device to the smart companion device.

12. The method of claim 11, wherein the calibration data is prepared for the mobile device by a user of the mobile device.

13. The non-transitory computer readable media of claim 11, wherein the calibration data is prepared for the mobile device by a manufacturer of the mobile device.

14. The non-transitory computer readable media of claim 9, wherein the configuration includes a distance threshold, the distance threshold defines a user selected operation that is performed when the distance between the mobile device and the smart companion device exceeds the distance threshold.

15. The non-transitory computer readable media of claim 14, wherein the distance threshold is configurable by a user of the mobile device through settings of the mobile device.

16. The non-transitory computer readable media of claim 9, wherein the configuration includes an operation that is performed when the smart companion device is unreachable or turned off.

17. A mobile device, comprising:
a transmission signal strength monitor;
a data store for storing a calibration data for mapping different values of transmitted signal strength to a distance;
a data store for storing a configuration for performing configured operations based on the distance; and
a user interface to change the configuration.

18. The mobile device of claim 17, wherein the calibration data provides a mapping between different values of measured transmission signal strength and distances of the mobile device to a smart companion device when paired with the mobile device.

19. The mobile device of claim 18, wherein the calibration data is prepared for the mobile device by a manufacturer of the mobile device.

20. The mobile device of claim 17, wherein the configuration includes a distance threshold, the distance threshold defines a user selected operation that is performed when the distance between the mobile device and the smart companion device exceeds the distance threshold.
